(19) United States
(12) Patent Application Publication
(10) Pub. No.: US 2008/0092592 A1
(43) Pub. Date: Apr. 24, 2008

(54) Manufactured Product for Jewellery and/or Costume Jewellery

(76) Inventor: Bottene Italo, Cavazzale Di Monticello Conte Otto (IT)

Correspondence Address: Martin P Hoffman;Hoffman Wasson & Gitler, 2461 South Clark Street Suite 522, Arlington, VA, 22202, US

(21) Appl. No.: 11/791,118

(22) PCT Filed: Nov. 23, 2005
(86) PCT No.: PCT/IB05/03518

§ 371 Date: May 21, 2007

(30) Foreign Application Priority Data
Nov. 23, 2004 (IT) VI2004U000032

(51) Int. Cl. A44C 27/00; B32B 15/04; C25D 5/44

(52) U.S. Cl. 63/34; 205/205; 205/80; 428/332; 428/469; 428/472

(57) ABSTRACT

A manufactured product for jewelry and/or costume jewelry, which comprises a jewel made in aluminium with at least one portion of its surface coated with a layer of at least either hard aluminium oxide or hard titanium oxides.

### TECHNICAL FIELD

The object of this invention is a manufactured product for jewelry and/or costume jewelry.

### BACKGROUND ART

It is common knowledge that in the last decade the decline of the gold market has been relentless especially in Italy.

People working in this sector have been pushed to find ways to overcome the crisis as best they can and this has led, in particular, to the development and application of alternative materials and the search for new markets with the hope things will pick up—for some an illusion, for others impossible.

For example, materials such as steel, leather, rubber and wood have been used as alternative materials to gold in making new products to add to the marketable range of items.

Alternatively, other materials like titanium, glass and artificial stones have made it possible for trade manufacturers and dealers to offer the market new objects and, thus doing, diversify their sources of gain.

All this has done nothing but forge a new way of conceiving jewelry in a framework that could even be called “third millennium gold-work”.

### DISCLOSURE OF THE INVENTION

The main aim of the present invention is to create a manufactured product for jewelry and/or costume jewelry that is particularly pleasant in its appearance.

Another aim is to create a manufactured product for jewelry and/or costume jewelry whose surface is smooth and reflecting, contrary to other materials currently used in this particular sector like, for instance, steel, titanium and wood, which are rather flat and not very shiny.

And yet another aim of the present invention is to come up with a manufactured product for jewelry and/or costume jewelry that is considerably lightweight and strong that can be worn comfortably and without the risk of breaking.

Another aim of the present invention is to obtain a product that is scratch proof and shock resistant meaning it neither scratches nor dents if it falls accidentally which translates into lower maintenance costs.

Another aim of the present invention is to have a manufactured product for jewelry and/or costume jewelry that is anti-allergic, able to fully meet the health requirements as regards precious and similar metals.

Another aim of the present invention is to be economically advantageous as it is made with considerably reduced costs compared to traditional products in precious metals and alloys.

This aim and other objects that will become better apparent hereinafter are achieved by the present manufactured product for jewelry and/or costume jewelry, characterised in that it comprises a jewel made in aluminium with at least one portion of its surface covered by at least one layer of either hard aluminium-oxide or hard titanium oxide.

### WAYS OF CARRYING OUT THE INVENTION

Further characteristics and advantages of the present invention will become better apparent from the following detailed description that follows of a preferred but not exclusive embodiment of a manufactured product for jewelry and/or costume jewelry.

According to the invention the manufactured product comprises a shaped jewel like, for instance, a ring, bracelet, necklace, earring, pendant, etc., that can be made in one founding or put together with different pieces, it can be forged from bars or sheets by die-casting and/or using machine tools (lathes, millers, shearing machines, presses, lasers, etc.).

The jewel is made in aluminium, advantageously of the 6xxx or 7xxx series and with at least one portion of its surface coated with at least one layer of either hard aluminium oxide or hard titanium oxide.

According to the classification used traditionally in this sector, aluminium of the 6xxx series is an alloy of aluminium, magnesium and silicon in variable quantities.

Based on this same classification, the aluminium of the 7xxx series is an aluminium and zinc alloy.

The hard aluminium and titanium oxides are, instead, formations of oxide obtained in the laboratory by means of low temperature electrolysis, dipping the aluminium jewel in an electrolytic acid.

These formations become the protective layer on the surface of the jewel which is remarkably hard (1100-1300 HV) and compact.

Once the jewel has been appropriately finished it has a pleasing appearance: beautifully smooth, reflecting and colourful.

In the case of hard aluminium oxide, the jewel, modelled and shaped using traditional techniques, is first polished and then dipped in a bath containing sulphuric acid at a low temperature (approx. 0° C.).

The jewel is anchored to the bath, keeping it suspended so it does not touch the bottom, and electrically connected so electricity can pass through it.

Advantageously, the intensity of the electrical current on the outer surface of the jewel is basically equivalent to about 3.5 A/dm².

By dipping the jewel in the bath for about 40 minutes, a coating of hard oxide forms that is from 25·10⁻⁶ m to 200·10⁻⁶ m thick.

Appropriately, this operation is regulated by the UNI 7796 standard that establishes the requirements and test methods to use on the hard oxide, obtainable on aluminium and its alloys.

For hard titanium oxide the procedure is identical to the one described previously with the difference that the electrolytic bath is made up of sulphuric acid, nitric acid and micro titanium particles.

After the hard oxide protective layer has been applied, the jewel can then be worked by superficially inserting one or more inserts made in a material chosen from the group including natural stones, gold, platinum, silver, artificial stones, etc. The result is a highly technological jewel of a truly refined elegance.

In practice it has been found that the described invention achieves the intended aim and objects.

The invention thus conceived is susceptible of numerous modifications and variations, all of which are within the scope of the appended claims.

All the details may further be replaced with other technically equivalent elements. In practice, the materials used, as well as the contingent shapes and dimensions, may be any according to the requirements without thereby abandoning the scope of the protection limits of the claims that follow.

The disclosures in Italian Patent Application no. V12004U000032, from which this application claims priority, are incorporated herein by reference.

1) Manufactured product for jewelry and/or costume jewelry, characterised in that it comprises a jewel made in aluminium with at least one surface portion coated with at least one layer of either hard aluminium oxide or hard titanium oxide.

2) The manufactured product according to claim 1, characterised in that said aluminium is either of the 6xxx or 7xxx series.

3) The manufactured product according to one or more of the preceding claims, characterised in that said layer of coating is applied by electrolysis.

4) The manufactured product according to one or more of the preceding claims, characterised in that said coating layer is applied in accordance with the UNI 7796 standard.

5) The manufactured product according to one or more of the preceding claims, characterised in that the thickness of said coating layer is between 25·10⁻⁶ m and 200·10⁻⁶ m.

6) The manufactured product according to one or more of the preceding claims, characterised in that the hardness of said coating layer is between 1100 HV and 1300 HV.

7) The manufactured product according to one or more of the preceding claims, characterised in that there is at least one insert on the surface of said jewel.

8) The manufactured product according to one or more of the preceding claims, characterised in that said insert is made in a material chosen from the group including: natural stones, gold, platinum, silver, artificial stones or the like.

9) The manufactured product according to one or more of the preceding claims, characterised in that said jewel is a ring.

10) The manufactured product according to one or more of the preceding claims, characterised in that said jewel is a bracelet.

11) The manufactured product according to one or more of the preceding claims, characterised in that said jewel is a necklace.

12) The manufactured product according to one or more of the preceding claims, characterised in that said jewel is an earring.

13) The manufactured product according to one or more of the preceding claims, characterised in that said jewel is a pendant.

14) Method for the production of a manufactured product for jewelry and/or costume jewelry according to one or more of the preceding claims characterised in that said method includes dipping said aluminium jewel in at least one electrolytic bath that includes at least sulphuric acid.

15) Method according to claim 14, characterised in that said jewel is anchored to said bath, suspended in relation to the bottom of the bath with electrical current running through it.

16) Method according to claims 14 and 15, characterised in that the intensity of the electrical current on the outer surface of said jewel is basically equivalent to 3.5 A/dm².

17) Method according to claims 14 and 15, characterised in that the dipping time of said jewel in said bath is basically equivalent to 40 minutes.

18) Method according to claim 14, characterised in that it includes polishing said jewel before being dipped.

19) Method according to claim 14, characterised in that said electrolytic bath includes at least either nitric acid or micro titanium particles.
